(19) United States
(12) Patent Application Publication
(10) Pub. No.: US 2012/0034011 A1
(43) Pub. Date: Feb. 9, 2012

(54) PRINTER AND WINDING ATTACHMENT

(75) Inventor: Haruo Hasegawa, Shizuoka (JP)

(73) Assignee: TOSHIBA TEC KABUSHIKI KAISHA, Shinagawa-ku, Tokyo (JP)

(21) Appl. No.: 13/159,638

(22) Filed: Jun. 14, 2011

(30) Foreign Application Priority Data
Aug. 5, 2010 (JP) 2010-176619

(51) Int. Cl. B41J 15/04

(52) U.S. Cl. 400/613

(57) ABSTRACT

A winding attachment which is detachably mounted on a winding shaft and on which a strip-shaped material is wound when the winding attachment mounted on the winding shaft is rotated. The winding attachment includes a winding section on which the strip-shaped material is wound, and an elastic member configured to reduce diameter of the winding section in the radial direction of a rotation axis of the winding shaft if the winding attachment is separated from the winding shaft compared to the diameter in case that the winding attachment is mounted on the winding shaft.

### CROSS-REFERENCE TO RELATED APPLICATIONS

This application is based upon and claims the benefit of priority from Japanese Patent Application No. 2010-176619, filed on Aug. 5, 2010, the entire contents of which are incorporated herein by reference.

### FIELD

Embodiments described herein relate generally to a printer and a winding attachment.

### BACKGROUND

Winding attachments around which a strip-shaped material (or web material), such as an ink ribbon, is wound are used in printers and printing devices.

In some types of printers, the strip-shaped material is wound into a roll around the winding attachment. In this case, it is desirable that the winding attachment is easily separated from the roll.

### BRIEF DESCRIPTION OF THE DRAWINGS

FIG. 1 is a side sectional view showing an example of an internal configuration of a printer according to a first embodiment.

FIG. 2A is a perspective view of a winding attachment of the printer, showing a state of a diameter thereof being enlarged.

FIG. 2B is a perspective view of the winding attachment of the printer, showing a state of a diameter thereof being reduced.

FIG. 3A is a side view of the winding attachment and a used-up ribbon roll of the printer, showing a state where the winding attachment and the used-up ribbon roll are mounted on a winding shaft,

FIG. 3B is a side view of the winding attachment and the used-up ribbon roll of the printer, showing a state where the winding attachment and the used-up ribbon roll are separated from the winding shaft.

FIG. 4 is a sectional view of the winding shaft and the winding attachment of the printer.

FIG. 5 is a perspective view of a winding attachment of a printer according to a second embodiment.

FIG. 6A is a side view of the winding attachment and a used-up ribbon roll of the printer, showing a state where the winding attachment and the used-up ribbon roll are mounted on a winding shaft.

FIG. 6B is a side view of the winding attachment and the used-up ribbon roll of the printer, showing a state where the winding attachment and the used-up ribbon roll are separated from the winding shaft.

FIG. 7 is an exploded perspective view of a winding shaft and a winding attachment of a printer according to a third embodiment.

FIG. 8A is a front view of a winding attachment of a printer according to a fourth embodiment.

FIG. 8B is a sectional view of the winding attachment of the printer taken along an IXb-IXb line shown in FIG. 8A.

### DETAILED DESCRIPTION

According to one embodiment, a printer includes a winding shaft configured to be rotatably driven, and a winding attachment which is detachably mounted on the winding shaft and on which a strip-shaped material is wound when the winding attachment mounted on the winding shaft is rotated. The winding attachment includes a winding section on which the strip-shaped material is wound, and an elastic member configured to reduce the diameter of the winding section in a radial direction of the rotation axis of the winding shaft when the winding attachment is separated from the winding shaft compared to when the winding attachment is mounted on the winding shaft.

Embodiments will now be described in detail with reference to the drawings. In the following embodiments, the same reference numerals refer to the same elements, and thus duplicate descriptions will be omitted.

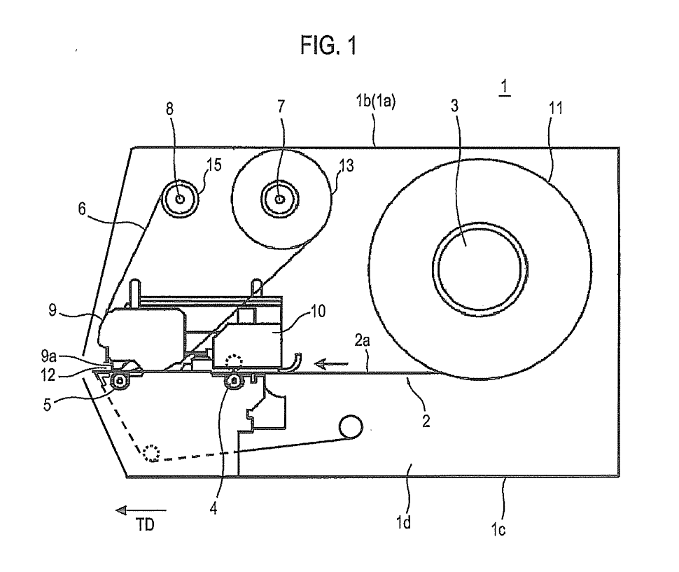

As shown in FIG. 1, a device (e.g., printer 1) according to an illustrative embodiment may print on a label (used as a printing medium) (not shown), which is provided on (e.g., adhered to) an inner surface 2a of a strip-shaped paper 2. In some embodiments, the printer 1 may print on a printing medium other than a label, for example, a continuous-form paper without a backing sheet. In addition, the printer 1 may write and read data to and from an RFID (Radio Frequency IDentification) chip attached on the label.

As shown in FIG. 1, a main body 1a of the printer 1 includes a housing 1b with a bottom wall 1c and a side wall. The housing 1b includes a longitudinal wall 1d provided perpendicular to the bottom wall 1c. A roll holding shaft 3, a conveying roller 4, a platen roller 5, a supply shaft 7 for an ink ribbon 6, a winding shaft (or take-up shaft) 8 for the ink ribbon 6, a print block 9, a pinch roller block 10, and the like are mounted on the longitudinal wall 1d. A control circuit (not shown) may be disposed on the rear side of the longitudinal wall 1d in the housing 1b.

The roll holding shaft 3 may rotatably hold a roll (e.g., a paper roll) 11, around which the strip-shaped paper 2 is wound. In one embodiment, the roll holding shaft 3 may be rotatably supported by the longitudinal wall 1d. Alternatively, the roll holding shaft 3 may be fixed on the longitudinal wall 1d, thereby allowing the paper roll 11 wound with the strip-shaped paper 2 to rotate around the roll holding shaft 3. In any case, in this embodiment, the roll holding shaft 3 and the paper roll 11 are not driven by, for example, a motor. The paper roll 11 wound with the strip-shaped paper 2 rotates (or is driven) in conjunction with rotation of the conveying roller 4 and the platen roller 5, which are located downstream of the paper roll 11 in a paper feeding direction TD (the left direction in FIG. 1). As such, the strip-shaped paper 2 is discharged from the paper roll 11.

The conveying roller 4 and the platen roller 5 may be rotary-driven by, for example, a motor. The conveying roller 4 is located upstream of the platen roller 5 and a print unit 12 in the paper feeding direction TD. The pinch roller block 10 may include a pinch roller (not shown) which is horizontally placed adjacent to the conveying roller 4. The pinch roller is biased towards the conveying roller 4 with predetermined pressure. The strip-shaped paper 2, interposed between the conveying roller 4 and the pinch roller, is conveyed in the paper feeding direction TD in conjunction with the rotation of the conveying roller 4. In this embodiment, the conveying roller 4, the platen roller 5, the motor, a motor controller, and the pinch roller block 10 may constitute a conveying mechanism.

A ribbon roll 13, around which a strip-shaped material (e.g., the ink ribbon 6) is wound, is held by the supply shaft 7 of the ink ribbon 6. The winding shaft 8 may be rotary-driven by, for example, a motor. With the rotation of the winding shaft 8, the ink ribbon 6 is wound around the winding shaft 8 while simultaneously being discharged from the ribbon roll 13. Both the ink ribbon 6 and the strip-shaped paper 2 are interposed between a thermal head 9a contained in the print head block 9 and the platen roller 5. The thermal head 9a generates heat, which allows ink on the ink ribbon 6 to melt or sublimate. Through such operation of the thermal head 9a, a predetermined pattern such as a character, numeric character, bar code, or graphic, is transferred onto a label which is provided on (e.g., attached to) the inner surface 2a of the strip-shaped paper 2. Specifically, in this embodiment, a print mechanism may include the ink ribbon 6, the supply shaft 7, the winding shaft 8, the print head block 9, the thermal head 9a, the motor, and the motor controller. The print unit 12 includes the thermal head 9a and the platen roller 5.

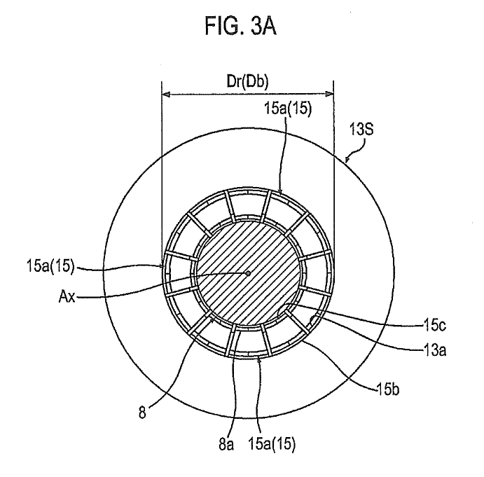

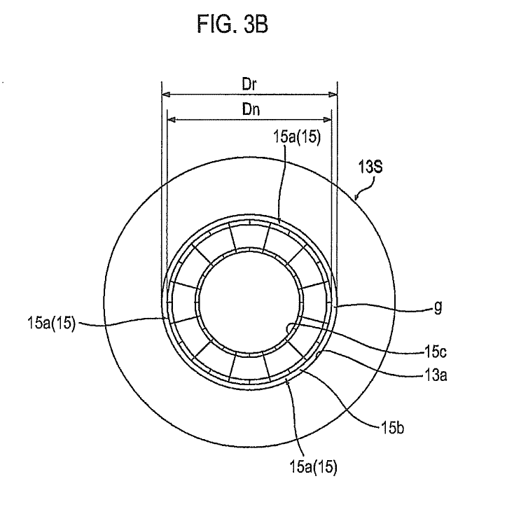

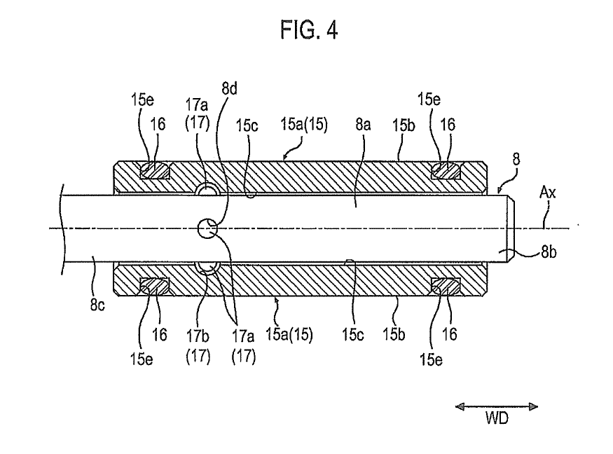

As shown in FIG. 1, a winding attachment 15 for the ink ribbon 6 is detachably mounted on the winding shaft 8. The winding attachment 15 is engaged with the winding shaft 8 via an engagement mechanism 17 (see FIG. 4) and is rotated along with the winding shaft 8. By employing the above configuration, the ink ribbon 6 is wound around the winding attachment 15. In this embodiment, the ink ribbon 6 is wound on a periphery 15b of the winding attachment 15 to form a used-up roll 13S of the ink ribbon 6 (see FIG. 3A). The use of the winding attachment 15 eliminates the need to install a pipe (e.g., a paper pipe) for winding the ink ribbon 6 at a discharge start end of the ink ribbon 6. Alternatively, if a pipe for winding the ink ribbon 6 is equipped at the discharge start end of the ink ribbon 6, an operator may separate the winding attachment 15 from the winding shaft 8 and replace the winding attachment 15 with the pipe for winding the ink ribbon 6. In this embodiment, the periphery 15b of the winding attachment 15 corresponds to a winding section around which the ink ribbon 6 is wound.

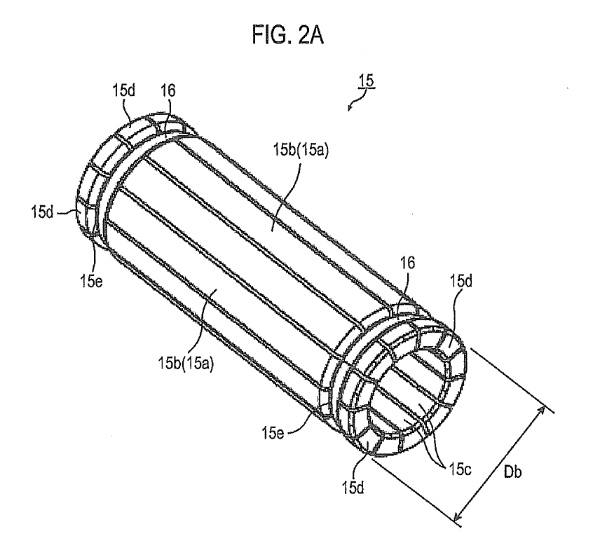

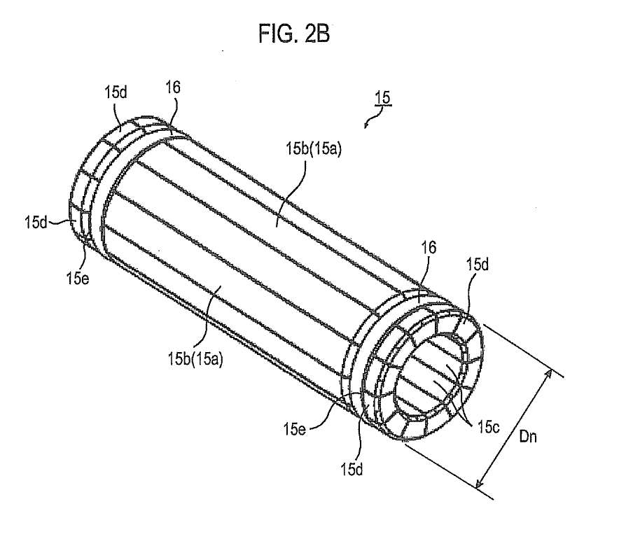

As shown in FIGS. 2A, 2B, 3A, and 3B, the winding attachment 15 includes a plurality of segments 15a (e.g., 12 segments in this embodiment) of the same shape and an O-ring 16 which is an elastic member configured to bind the segments 15a. The winding attachment 15 is mounted to surround the winding shaft 8. The winding attachment 15 may be mounted on or detached from the winding shaft 8 in the shaft direction of the winding shaft 8. In addition, as shown in FIGS. 2A and 2B, ring-shaped grooves 15e are formed around the center axis of the winding attachment 15 in the vicinity of both end portions of the periphery 15b of the segments 15a in the longitudinal direction thereof. The O-ring 16 is inserted in the groove 15e. The segments 15a may be made of synthetic resin, metal, or the like. The 0-ring 16 may be made of an elastomer. In this embodiment, the O-ring 16 corresponds to an elastic ring.

As shown in FIG. 3A, when the winding attachment 15 is mounted on the winding shaft 8, the plurality of segments 15a having the same shape are arranged side by side in a circumferential direction of a rotation axis Ax on an outer circumference 8a of the winding shaft 8. In this configuration, as shown in FIG. 3A, inner circumferences 15c of the segments 15a are in contact with the outer circumference 8a of the winding shaft 8. In addition, as shown in FIG. 2A and FIG. 3A, gaps (i.e., gaps in the circumferential direction) are formed between the adjacent segments 15a.

On the other hand, when the winding attachment 15 is separated from the winding shaft 8, the segments 15a are bound by the O-ring 16 and are held in the form of a pipe as shown in FIG. 2B and FIG. 3B. Accordingly, an outer diameter Dn (see FIG. 3B) of the winding attachment 15 when it is separated from the winding shaft 8 is smaller than an outer diameter Db (see FIG. 3A) of the winding attachment 15 when it is mounted on the winding shaft 8.

As described above, since the used-up roll 13S is formed around the winding attachment 15 mounted on the winding shaft 8, an inner diameter Dr of the used-up roll 13S is substantially equal to the outer diameter Db of the winding attachment 15 when the winding attachment 15 is mounted on the winding shaft 8 (see FIG. 3A). On the other hand, as shown in FIG. 3B, the outer diameter Dn of the winding attachment 15 is smaller than the inner diameter Dr of the used-up roll 13S when the winding attachment 15 is separated from the winding shaft 8. Accordingly, in this embodiment, when an operator separates the winding attachment 15 with the used-up roll 13S of the ink ribbon 6 formed thereon from the winding shaft 8 in an axial direction, the diameter of the winding attachment 15 is decreased by the O-ring 16 (serving as an elastic member). As a result, a gap g is formed between the periphery 15b of the winding attachment 15 and an inner circumference 13a of the used-up roll 13S, as shown in FIG. 3B. Thus, the operator may more easily separate the used-up roll 13S from the winding attachment 15.

In addition, as shown in FIG. 4, a plurality of projections 17a, which are retractable, is formed on the outer circumference 8a of the winding shaft 8 at a position closer to a base end section 8c than a leading end section 8b (in a direction WD). These projections 17a are outward biased by a biasing member (not shown) such as a leaf spring or a coil spring so that the projections 17a protrude outward from through holes 8d formed on the outer surface of the winding shaft 8 in a free state where no external force is exerted. On the other hand, concave sections 17b into which the projections 17a are to be inserted are formed on the inner circumference 15c of the winding attachment 15. When the winding attachment 15 is mounted on the winding shaft 8, the projections 17a are engaged with the concave sections 17b in the circumferential and axial direction of the rotation axis Ax of the winding shaft 8. In this embodiment, an engagement mechanism 17 includes the projections 17a and the concave sections 17b. This engagement mechanism 17 prevents the winding attachment 15 from separating from the winding shaft 8 and allows the winding attachment 15 to be rotated in conjunction with the winding shaft 8. While the winding attachment 15 is mounted on or separated from the winding shaft 8, the projections 17a retract due to the projections 17a being pressed down by the winding attachment 15.

As described above, in this embodiment, the winding attachment 15 includes the outer circumference 15b around which the strip-shaped ink ribbon 6 is wound. The winding attachment further includes the O-ring 16 serving as the elastic member configured to reduce the outer circumference 15b further when the winding attachment 15 is separated from the winding shaft 8 than when the winding attachment 15 is mounted on the winding shaft 8. In this embodiment, since the diameter of the winding attachment 15 is decreased by the O-ring 16 when the winding attachment 15 is separated from the winding shaft 8, the operator may more easily separate the used-up roll 13S from the winding attachment 15.

In this embodiment, the winding attachment 15 includes the plurality of segments 15a which are arranged side by side in the circumferential direction of the rotation axis Ax on the outer circumference of the winding shaft 8, with the outer circumference 15b constituting a winding section, and the O-ring 16 serving as the elastic member and an elastic ring to bind the plurality of segments 15a together. With this configuration, the winding attachment 15 which is decreased in diameter by the elastic member when the winding attachment 15 is separated from the winding shaft 8 can be implemented using a relatively simple structure. Alternatively, a coil spring may be employed in place of the O-ring 16, as an elastic member configured to be wound around the winding shaft 8 in the circumferential direction.

In addition, in this embodiment, the projections 17a and the concave sections 17b are provided as the engagement mechanism 17 to engage the winding attachment 15 with the winding shaft 8 in the axial direction of the rotation axis Ax. This engagement mechanism 17 may prevent the winding attachment 15 from separating from the winding shaft 8. Alternatively, the engagement mechanism 17 may be constituted by concave sections formed on the winding shaft 8 and convex sections formed on the winding attachment 15.

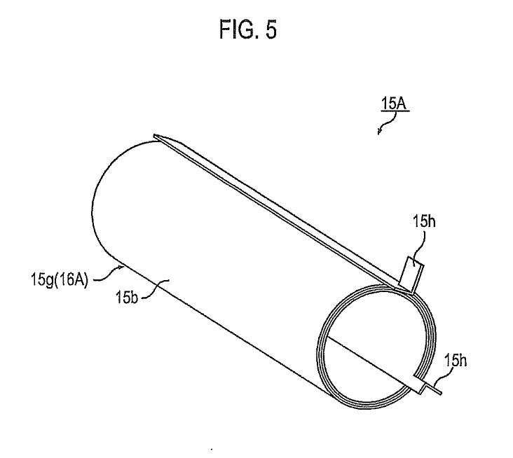

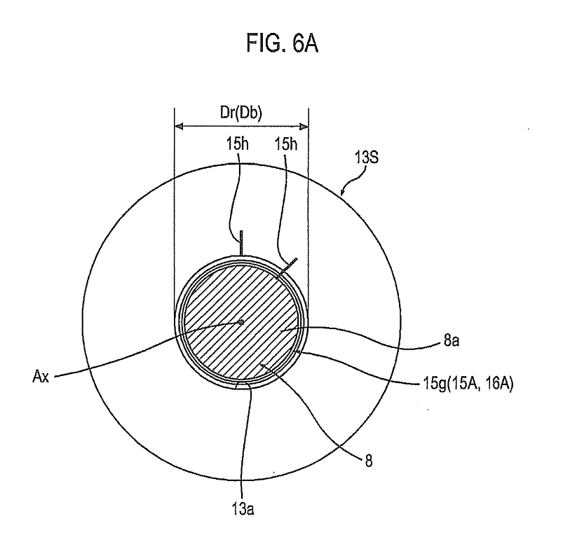

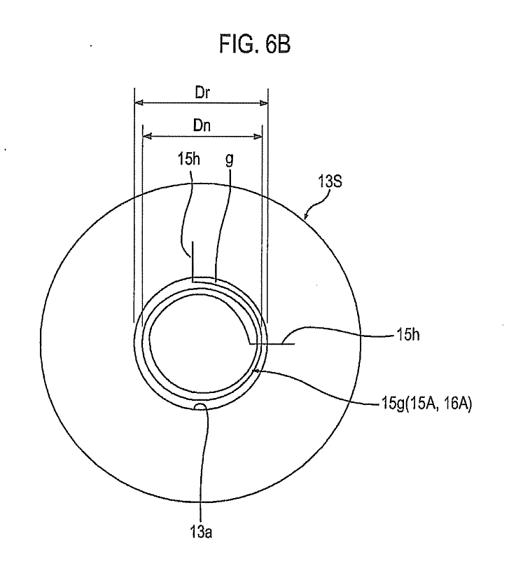

FIGS. 5, 6A, and 6B illustrate a winding attachment of a printer according to a second embodiment. In the second embodiment as shown in PIGS. 5, 6A, and 6B, a winding attachment 15A may be employed in place of the winding attachment 15 of the first embodiment. In this embodiment, the winding attachment 15A includes a spiral spring 15g having a plate spirally wound around the winding shaft 8, as an elastic member 16A. The spiral spring 15g may be formed by spiraling metal material such as, for example, spring steel or stainless steel.

When the winding attachment 15A is mounted on the winding shaft 8, the ink ribbon 6 is wound around an outer circumference 15b of the spiral spring 15g to form the used-up roll 13S. In this embodiment, the outer circumference 15b of the spiral spring 15g corresponds to a winding section. In addition, when the winding attachment 15A is mounted on the winding shaft 8, the winding shaft 8 is engaged with the spiral spring 15g in the rotational and axial directions by an engagement mechanism (not shown).

In this embodiment, the spiral spring 15g is mounted on the winding shaft 8 with its diameter increased elastically. Accordingly, an outer diameter Dn of the spiral spring 15g when the spiral spring 15g is separated from the winding shaft 8, as shown in FIG. 6B, is smaller than an outer diameter Db of the spiral spring 15g when the spiral spring 15g is mounted on the winding shaft 8, as shown in FIG. 6A. Thus, in this embodiment, when an operator separates the winding attachment 15A with the used-up roll 13S of the ink ribbon 6 formed thereon from the winding shaft 8, the diameter of the spiral spring 15g constituting the winding attachment 15A is decreased by its own elasticity. As a result, a gap g is formed between the periphery (or outer circumference) 15b of the winding attachment 15A (the spiral spring 15g) and an inner circumference 13a of the used-up roll 13S as shown in FIG. 6B. Therefore, the operator may more easily separate the used-up roll 13S from the winding attachment 15A,

In addition, the winding attachment 15A includes handlers 15h formed at end portions of the inner and outer circumferences of the spiral spring 15g, respectively. The handlers 15h protrude outward in a radial direction of a center axis of the spiral spring 15g (i.e., a radial direction of the rotation axis Ax of the winding shaft 8 when the spiral spring 15g is mounted on the winding shaft 8, see FIG. 6A) at end portions of the spiral spring 15g. Accordingly, the operator may easily change the diameter of the spiral spring 15g by moving these two handlers 15h with respect to each other along a circumferential direction using his/her own fingers or the like. Specifically, for example, the operator may easily increase the diameter of the spiral spring 15g and detachably mount the winding attachment 15A on the winding shaft 8 by moving these two handlers 15h with respect to each other along a circumferential direction using his/her own fingers or the like. In addition, the operator may easily decrease the diameter of the spiral spring 15g and separate the used-up roll 13S from the winding attachment 15A by moving these two handlers 15h with respect to each other along a circumferential direction using his/her own fingers or the like. Furthermore, the operator may easily mount the winding attachment 15A on the winding shaft 8 by means of a tapered section (not shown) formed at a lead end section of the winding shaft 8.

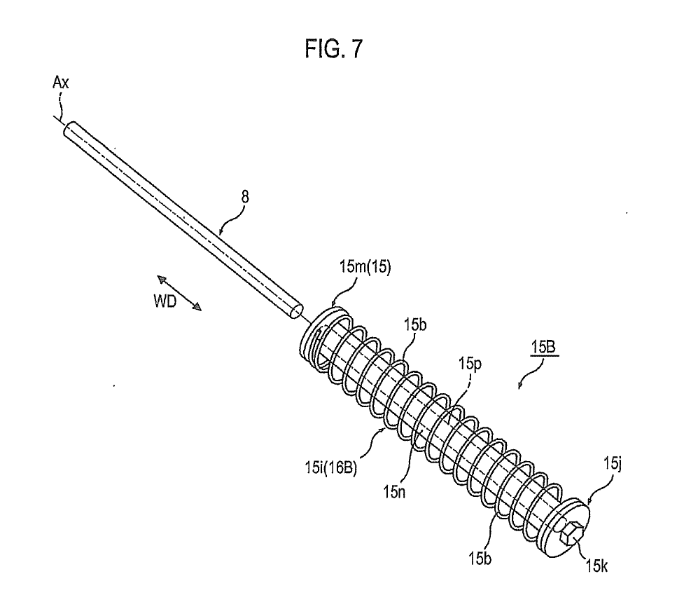

FIG. 7 illustrates a winding attachment of a printer according to a third embodiment. In the third embodiment, as shown in FIG. 7, a winding attachment 15B may be employed in place of the winding attachment 15 of the first embodiment. In this embodiment, the winding attachment 15B includes a coil spring 15i having a wire spirally wound around the winding shaft 8, as an elastic member 16B. The coil spring 15i is interposed between two clamping member 15j and 15m which are disposed at both axial end portions of the coil spring 15i. When mounting the coil spring 15i on the winding shaft 8, the coil spring 15i is axially compressed and is increased in diameter. The clamping members 15j and 15m are interconnected via a tubular member 15n fixed to one of the clamping members 15j and 15m (for example, the clamping member 15m in this embodiment). The tubular member 15n and the other clamping member (for example, the clamping member 15j in this embodiment) are connected to each other by means of a screw 15k. In addition, when the winding attachment 15B is mounted on the winding shaft 8, the winding shaft 8 is inserted into an internal tube 15p of the tubular member 15n and the winding shaft 8 is engaged with the tubular member 15n in the rotational and axial directions by means of an engagement mechanism (not shown).

When the winding attachment 15B is mounted on the winding shaft 8, the ink ribbon 6 is wound around the outer circumference 15b of the coil spring 15i to form the used-up roll 13S (not shown in FIG. 7, see FIG. 3A, etc.). In this embodiment, the outer circumference 15b of the coil spring 15i corresponds to a winding section.

In this embodiment, when the coil spring 15i is mounted on the winding shaft 8, the coil spring 15i is compressed axially and its diameter is increased elastically. On the other hand, when the coil spring 15i is separated from the winding shaft 8 and the clamping members 15j and 15m are released from each other, the coil spring 15i is expanded axially and its diameter is decreased elastically. Accordingly, in this embodiment, when an operator separates the winding attachment 15B with the used-up roll 13S formed thereon from the winding shaft 8 and the clamping members 15j and 15m are released from each other, the diameter of the coil spring 15i is decreased by its own elasticity. As a result, similarly to the first and second embodiments, a gap g is formed between the periphery (or outer circumference) 15b of the winding attachment 15B (the coil spring 15i) and the inner circumference 13a of the used-up roll 13S (not shown in FIG. 7, see FIG. 3A). Thus, in this embodiment, the operator may more easily separate the used-up roll 13S from the winding attachment 15B.

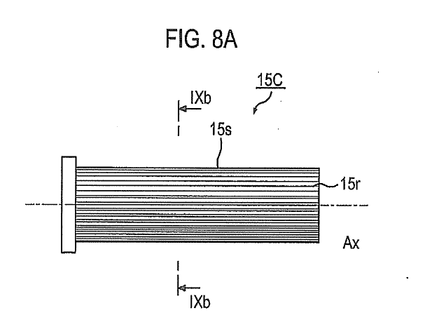

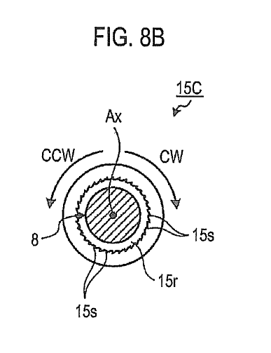

FIGS. 8A and 8B illustrate a winding attachment of a printer according to a fourth embodiment. In the fourth embodiment as shown in FIGS. 8A and 8B, a winding attachment 15C may be employed in place of the winding attachment 15 of the first embodiment. In this embodiment, the winding attachment 15C includes a tubular member 15r mounted to surround the winding shaft 8. The winding attachment 15C further includes a plurality of nail sections 15s which are formed on the outer circumference of the tubular member 15r and protrude in a radial and rotational direction (e.g., a clockwise direction CW in this embodiment) of the winding shaft 8. The plurality of nail sections 15s are circumferentially arranged with the same shape at regular intervals and extend in the axial direction of the winding shaft 8. In addition, when the winding attachment 15C is mounted on the winding shaft 8, the winding shaft 8 is engaged with the tubular member 15r in the rotational and axial directions by means of an engagement mechanism (not shown).

When the winding attachment 15C is mounted on the winding shaft 8, the ink ribbon 6 is wound around the tubular member 15r (nail sections 15s) to form the used-up roll 13S (not shown in FIGS. 8A and 8B, see FIG. 3A, etc.). In this embodiment, the tubular member 15r corresponds to a winding section.

In this embodiment, since the nail sections 15s protrude in the radial direction and the rotational direction (e.g., a clockwise direction CW in this embodiment) of the winding shaft 8, the nail sections 15s burrow into the ink ribbon 6 during rotation of the winding attachment 15C, thereby preventing the ink ribbon 6 from separating from the winding attachment 15C. On the other hand, when an operator separates the winding attachment 15C with the used-up roll 13S formed thereon from the winding shaft 8 and then rotates the winding attachment 15C in a counterclockwise direction CCW, the nail sections 15s are released from the ink ribbon 6. That is, in this embodiment, when the operator rotates the winding attachment 15C in an opposite direction (e.g., the counterclockwise direction CCW in this embodiment) to a burrowing direction of the nail sections 15s (e.g., the clockwise direction CW in this embodiment), the operator may more easily separate the used-up roll 13S from the winding attachment 15C.

While exemplary embodiments of the present disclosure have been shown and described above, various modifications and alterations may be made without being limited to the disclosed embodiments. For example, the present disclosure may be practiced as a part of a printer, a conveying apparatus, an electronic apparatus, an office equipment, etc., in addition to the label printer. In addition, the elastic ring may be formed in an axial end portion of the segments, inside thereof, etc., other than the outer circumference thereof. In addition, specifications (form, structure, shape, size, length, width, height, thickness, section, weight, number, material, arrangement, position, etc.) of various elements (printer, winding shaft, strip-shaped material, print medium, winding attachment, winding section, elastic member, segment, elastic ring, spiral spring, coil spring, nail section, etc.) may be properly changed for practice.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a winding shaft configured to be rotatably driven; and
a winding attachment which is detachably mounted on the winding shaft and on which a strip-shaped material is wound if the winding attachment mounted on the winding shaft is rotated, the winding attachment including:
a winding section which has a diameter in a radial direction of a rotation axis of the winding shaft and on which the strip-shaped material is wound; and
an elastic member configured to reduce the diameter of the winding section if the winding attachment is separated from the winding shaft compared to the diameter in case that the winding attachment is mounted on the winding shaft.

2. The printer of claim 1, wherein the winding attachment comprises a plurality of segments which are arranged side by side around the rotation axis on an outer circumference of the winding shaft, and wherein the elastic member is an elastic ring configured to bind the plurality of segments together.

3. The printer of claim 1, wherein the elastic member is a spiral spring comprising a plate spirally wound around the winding shaft, an outer circumference of the spiral spring constituting the winding section, and wherein an outer diameter of the spiral spring is elastically decreased if the winding attachment is separated from the winding shaft compared to the diameter in case that the winding attachment is mounted on the winding shaft.

4. The printer of claim 1, wherein the elastic member is a coil spring comprising a wire spirally wound around the winding shaft, an outer circumference of the coil spring constituting the winding section, and wherein an outer diameter of the coil spring is elastically decreased if the winding attachment is separated from the winding shaft compared to the diameter in case that the winding attachment is mounted on the winding shaft.

5. A printer comprising:
a winding shaft configured to be rotatably driven; and
a winding attachment which is detachably mounted on the winding shaft and on which a strip-shaped material is wound when the winding attachment mounted on the winding shaft is rotated,
the winding attachment including:
a winding section on which the strip-shaped material is wound; and
a nail section which is formed on an outer circumference of the winding section and protrudes in a radial and rotational direction of the winding shaft.

6. A winding attachment which is detachably mounted on a winding shaft, the winding attachment comprising:
a winding section on which the strip-shaped material is wound; and
an elastic member configured to reduce the diameter of the winding section if the winding attachment is separated from the winding shaft compared to the diameter in case that the winding attachment is mounted on the winding shaft.

7. The winding attachment of claim 6, further comprising a plurality of segments which are arranged side by side around the rotation axis on an outer circumference of the winding shaft, wherein the elastic member is an elastic ring configured to bind the plurality of segments together.

8. The winding attachment of claim 6, wherein the elastic member is a spiral spring comprising a plate spirally wound around the winding shaft, an outer circumference of the spiral spring constituting the winding section, and wherein an outer diameter of the spiral spring elastically decreases if the winding attachment is separated from the winding shaft compared to the outer diameter in case that the winding attachment is mounted on the winding shaft.

9. The winding attachment of claim 6, wherein the elastic member is a coil spring comprising a wire spirally wound around the winding shaft, an outer circumference of the coil spring constituting the winding section, and wherein an outer diameter of the coil spring elastically decreases if the winding attachment is separated from the winding shaft compared to the outer diameter in case that the winding attachment is mounted on the winding shaft.
